(19) United States
(12) Patent Application Publication
(10) Pub. No.: US 2016/0113438 A1
(43) Pub. Date: Apr. 28, 2016

(54) SYSTEM AND METHOD FOR CUSTOMIZED CONTROL AND MONITORING OF COMMERCIAL KITCHEN EQUIPMENT

(71) Applicant: Value Added Services & Technology, Inc., Elgin, IL (US)

(72) Inventors: James Jeffery Hanson, Elgin, IL (US); Ricky Joe Sullivan McIntosh, Altoona, IA (US)

(21) Appl. No.: 14/921,393

(22) Filed: Oct. 23, 2015

Related U.S. Application Data
(60) Provisional application No. 62/118,284, filed on Feb. 19, 2015.
(60) Provisional application No. 62/067,735, filed on Oct. 23, 2014.

(51) Int. Cl. A47J 36/00; H04W 4/00; G05B 15/02

(52) U.S. Cl. CPC A47J 36/00; G05B 15/02; H04W 4/008

(57) ABSTRACT

Aspects of the disclosure relate to systems and methods for customized control, monitoring, and analysis of commercial kitchen equipment. Example systems and methods include utilizing on-board servers on commercial kitchen equipment to provide remote access to operational information, real-time access to operational information, and mirrored control of commercial kitchen equipment using local and/or remote devices associated with the equipment.

### CROSS-REFERENCE TO RELATED APPLICATIONS

This application claims the benefit of U.S. Provisional Patent Application No. 62/067,735 entitled “System and Method for Customized Control and Monitoring of Commercial Kitchen Equipment” and filed on Oct. 23, 2014 which is incorporated by reference herein in its entirety. This application also claims the benefit of U.S. Provisional Patent Application No. 62/118,284 entitled “System and Method for Customized Control and Monitoring of Commercial Kitchen Equipment” and filed on Feb. 19, 2015 which is incorporated by reference herein in its entirety.

### TECHNICAL FIELD

Aspects of the disclosure generally relate to systems and methods for control and monitoring of commercial kitchen equipment. In particular, various aspects of the disclosure relate to receiving information pertaining to operation of commercial kitchen equipment and using and determining aspects of controlling, monitoring, and reporting of such information.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to systems and methods for receiving information pertaining to customized control and monitoring of commercial kitchen equipment; collecting operating information from sensors or devices associated with a commercial kitchen equipment device, such operating information can include, for example, temperature information, time, energy consumption rate, humidity, door open/closed position, and/or cooking duration; analyzing the operating information, such analysis can include comparison of the operating information with an operating protocol, calculation of a property of the operation of the commercial kitchen equipment (such as cost of energy consumption), and/or identification of operating information to include in a report or notification; generate a report or notification regarding the analysis of the operating information; and sending the report or notification to a mobile device or server configured to be accessed by authorized users.

In an embodiment, a device is configured to provide commercial kitchen equipment control and monitoring. The device can include a commercial kitchen equipment unit having equipment operational sensors, an input/output unit operatively connected to the commercial kitchen equipment unit, a wireless communications unit operatively connected to the input/output unit, a processor, and a memory unit. In an embodiment, the system is configured via the processor to collect operating information from the operational sensors of the commercial kitchen equipment unit and transmit via the wireless communications unit at least a portion of the operating information to a remote device.

In an embodiment, the device is configured to provide control and monitoring of commercial kitchen equipment via an on-board web server installed on a wireless communications unit of the commercial kitchen equipment unit. In an embodiment, the device can be further configured to provide operational information of the commercial kitchen equipment in real-time to the remote device via the on-board web server. In an embodiment, the device is configured to provide for mirrored control and monitoring of commercial kitchen equipment by displaying on a remote device a reproduction of the graphical user interface used on an equipment display of the commercial kitchen equipment. In an embodiment, the graphical user interface used to control the commercial kitchen equipment unit via the equipment display and the reproduction of the graphical user interface on the remote device are substantially the same.

### BRIEF DESCRIPTION OF THE DRAWINGS

A more complete understanding of the present disclosure and the advantages thereof may be acquired by referring to the following description in consideration of the accompanying drawings, in which like reference numbers indicate like features, and wherein:

FIG. 1 illustrates a network environment and computing systems that may be used to implement aspects of the disclosure.

FIG. 2 is a diagram illustrating an example hardware connectivity configuration of aspects of the disclosure.

FIG. 3 is a drawing of an example I/O unit used in aspects of the disclosure.

FIG. 4 is a drawing of an example display with integrated WiFi unit used in aspects of the disclosure.

FIG. 5 illustrates an example display of operating information of a commercial kitchen equipment unit on mobile devices.

### DETAILED DESCRIPTION

In the following description of the various embodiments, reference is made to the accompanying drawings, which form a part hereof, and in which is shown by way of illustration, various embodiments of the disclosure that may be practiced. It is to be understood that other embodiments may be utilized.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment, or an embodiment combining software and hardware aspects. In addition, aspects may take the form of a computing device configured to perform specified actions. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

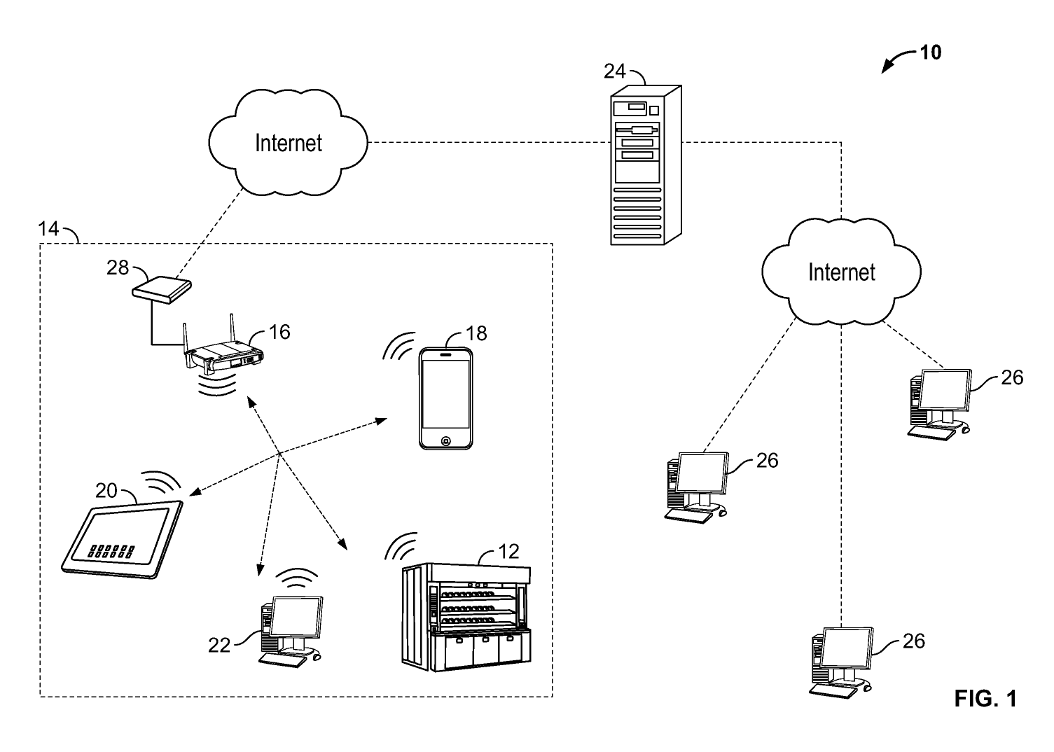

FIG. 1 illustrates a diagram of an example system 10 for monitoring, controlling, and/or analyzing performance of commercial kitchen equipment that may be used according to one or more illustrative embodiments of the disclosure. The system 10, can utilize one or more processors for controlling overall operation and associated components, including RAM, ROM, input/output unit, memory unit, display, and/or Wifi unit. The system 10, along with one or more additional and/or component devices may correspond to any of multiple systems or devices, such as a computing device, communication device, control device, monitoring device, or system for processing of aspects of a customized control and monitoring of commercial kitchen equipment. The system 10, along with one or more additional devices may be configured as described as shown in the figures herein for transmitting and receiving information and data pertaining to, for example, the operation, control, analysis, and/or monitoring of commercial kitchen equipment.

As shown in the embodiment illustrated in FIG. 1, the system 10 can utilize and/or include devices in communication with kitchen equipment 12 in a commercial kitchen 14. Kitchen equipment 12 can include, for example, an oven, a stove, a fryer, a grill, a warmer, a smoker, a refrigerator, a mixer, a scale, coffee makers, drink dispensers, holding cabinets, rethermalizing cabinets, freezers, proofing cabinets, condiment and food dispensers, serving stations, hoods, ice cream dispensers, smoothie machines and/or other kitchen equipment. As shown in FIG. 1, the kitchen equipment 12 can be in communication with, for example, a wireless router 16, a mobile phone 18, a tablet computer 20, or other computer device having user interface, such as a personal desktop or laptop computer 22. The kitchen equipment 12 may further be in communication with a server 24 and additional remote computer access stations 26. Such communication can be established through, for example, an Internet connection. In an example, a wireless router 16 in communication with the kitchen equipment 12 is in communication with modem 28 which is connected and provides access to the Internet.

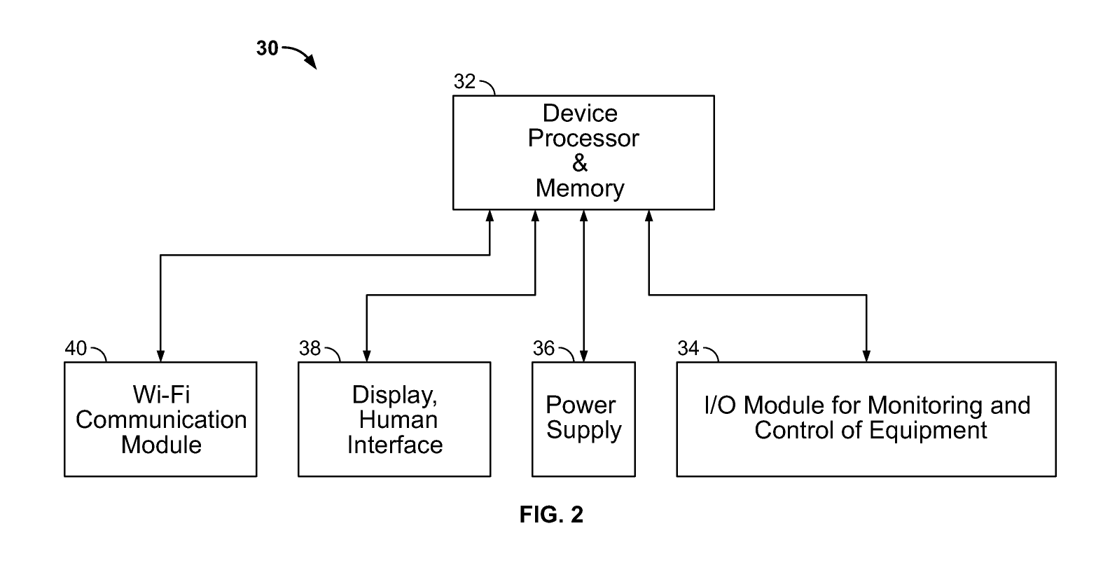

Referring to FIG. 2, in an embodiment, the system 10 can include a device 30 configured for controlling, monitoring, and/or communicating with kitchen equipment 12. The device 30 can include and/or utilize a computer processor and associated memory unit 32 for storing and executing instructions to operate the device 30. The device can include a kitchen equipment I/O unit 34 configured to control and/or monitor physical aspects of the kitchen equipment 12. Example physical aspects include temperature, fans, power consumption, heaters, lights, alarms, etc. The device 30 can include a power supply 36 and a human interface 38. The interface 38 can include, for example, a touch screen, a keypad, other interface hardware. The device 30 can include a WiFi communication unit 40 configured to provide wireless communication between the kitchen equipment 12 and other devices, e.g. wireless router 16, mobile phone 18, tablet computer 20, and desktop computer 22.

The WiFi communication unit 40 may be configured to exchange wireless communications using one or more of the 802.11 protocols. In other embodiments, a device may include a cellular communication unit to exchange wireless communications via a cellular network. Additionally or alternatively, a device may include a wired communication unit, e.g., an Ethernet communication unit, to exchange wired communications.

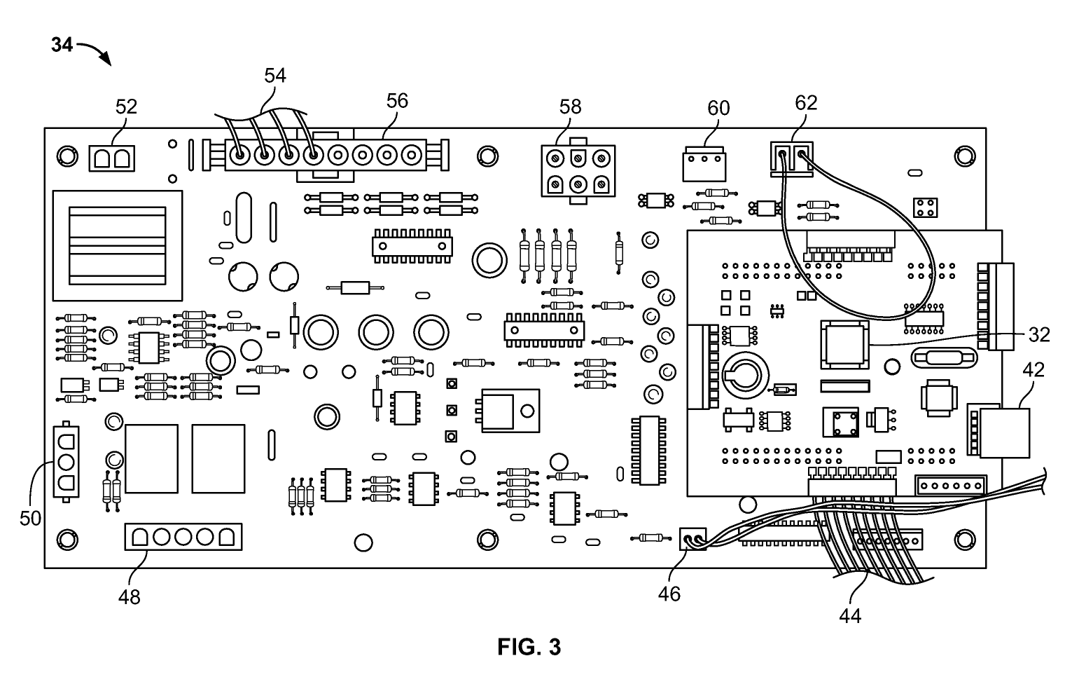

Referring to FIG. 3, in an embodiment, the kitchen equipment I/O unit 34 can include a plurality of devices and components. In an embodiment, the I/O unit 34 can include the device processor & memory 32 integrated thereon. In an embodiment, the I/O unit 34 can include a communication port 42 (e.g., a Universal Serial Bus/USB port) for uploading and/or downloading information to and/or from the device 30. In an embodiment, the I/O unit 34 can include a connection 44 to a display of the kitchen equipment 12. In an embodiment, the I/O unit 34 can include a temperature sensor input 46 for a thermocouple or other temperature sensor of the kitchen equipment 12. In an embodiment, the I/O unit 34 can include inputs 48 for fan and light control. In an embodiment, the fan and/or light control includes an electrical current sensor for power monitoring and component testing. In an embodiment, the I/O unit 34 can include fan speed sensor input 50 for receiving signals from the fan speed sensor. In an embodiment, the I/O unit 34 can include an incoming high voltage input 52 for measuring power usage. In an embodiment, the I/O unit 34 can include an external power input 54 for powering the I/O unit. In an embodiment, the I/O unit can include solid state relay driver outputs 56. In an embodiment, the I/O unit can include input for water supply control and an alarm 58. In an embodiment, the I/O unit can include flow meter input 60. In an embodiment, the I/O unit can include a door switch input 62 for determining the position of the door of the kitchen equipment 12. In an embodiment, the components of the I/O unit are configured on an I/O board with integrated power supply.

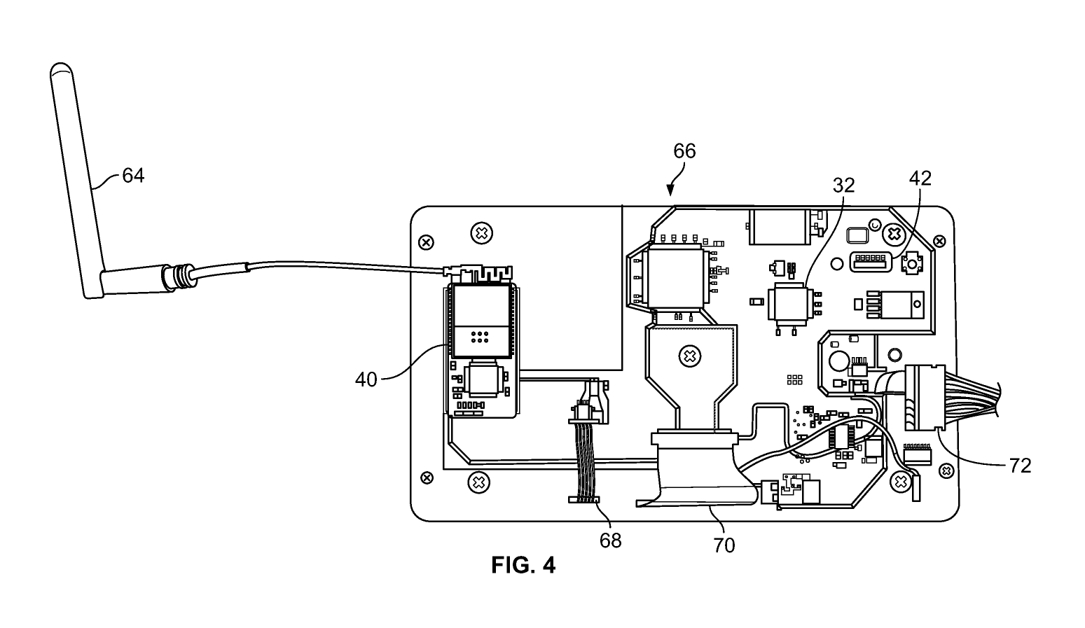

Referring to FIG. 4, in an embodiment, the device 30 can include a display 66 including plurality of devices and components. In an embodiment, the display 66 can include a communications unit 40 integrated thereon (e.g., a WiFi communications unit). The communications unit 40 can be operatively connected to an antenna 64. In an embodiment, the display 66 can include the device processor & memory 32 integrated thereon, and optionally including a communication port 42 (e.g., a USB port) for uploading and/or downloading information to and/or from the device 30. In an embodiment, the display 66 can include a plurality of connections to display components, including for example a touchscreen connection 68, a TFT (Thin Film Transistor) screen connection 70, and a display connection 72.

Input/Output (I/O) components may include a microphone, keypad, touch screen, and/or stylus through which a user of the commercial kitchen equipment and/or system 10 may provide input, and may also include one or more of a speaker and microphone for providing audio input/output and a video display device for providing textual, audiovisual and/or graphical output. In an embodiment, the system 10 through an I/O can monitor, analyze, and control operation of a commercial kitchen equipment device 12. In an example, the I/O of the system 10 can receive information from sensors, such as temperature, humidity, water level, water flow and consumption rate, current, and voltage of commercial kitchen equipment 12. In an example, the I/O can receive inputs such as door switch (open/closed), fan speed, line frequency, air flow, and belt speed of commercial kitchen equipment. In an example, the I/O can send control outputs, including for example to turn on and off fans, lights, heaters, compressors, steam valves, humidifies, and/or alarms of commercial kitchen equipment. In an example, the I/O can send and/or receive proportional/analog outputs for monitoring and/or control of commercial kitchen equipment, including for example, for variable control of heating and cooling, belt speed, water feed, airflow, and/or fan speed control.

Software may be stored within a memory unit and/or other storage to provide instructions to a processor for enabling the system 10 to perform various functions. For example, memory unit may store software used by the device 30, an operating system of the device 30, application programs of the device 30, and/or an associated internal or external database. The memory unit can include one or more of volatile and/or non-volatile computer memory to store computer-executable instructions, data, and/or other information. The processor and its associated components may allow the device 30 to receive information corresponding to a plurality of operating information from sensors or devices associated with a unit or units of commercial kitchen equipment 12, such operating information can include, for example, temperature information, time, energy consumption rate, humidity, door open/closed, and/or cooking duration; analyzing the operating information, such analysis can include comparison of the operating information with an operating protocol, calculation of a property of the operation of the commercial kitchen equipment (such as cost of energy consumption), and/or identification of operating information to include in a report or notification; generate a report or notification regarding the analysis of the operating information; and sending the report or notification to a mobile device or server configured to be accessed by authorized users.

The device 30 may operate in a networked environment supporting connections to one or more remote computers, such as terminals/devices. Thus, the device 30 and terminals/devices may each include personal computers (e.g., laptop, desktop, or tablet computers), servers (e.g., web servers, database servers), and/or mobile communication devices (e.g., mobile phones, portable computing devices, and the like), or commercial monitoring devices, and may include some or all of the elements described above with respect to the device 30. The network connections depicted in FIG. 1 include a local area network (LAN) and a wide area network (WAN), and a wireless telecommunications network, but may also include other networks. When used in a LAN networking environment, the device 30 may be connected to the LAN through a network interface or adapter. When used in a WAN networking environment, the device 30 may include a WiFi unit or other means for establishing communications over the WAN, such as the Internet). When used in a wireless telecommunications network, the device 30 may include one or more transceivers, digital signal processors, and additional circuitry and software for communicating with wireless computing devices (e.g., mobile phones, tablets) via one or more network devices (e.g., base transceiver stations) in the wireless network.

It will be appreciated that the network connections shown in the figures are illustrative and other means of establishing a communications link between the computers may be used. The existence of any of various network protocols such as TCP/IP, Ethernet, FTP, HTTP and the like, and of various wireless communication technologies such as GSM, CDMA, WiFi, and WiMAX, is presumed, and the various computing devices and driving analysis system components described herein may be configured to communicate using any of these network protocols or technologies.

Additionally, one or more application programs used by the device 30 may include computer executable instructions (e.g., analysis programs, operational data determination algorithms, operational property algorithms, preventative maintenance algorithms, and food preparation and cooking algorithms) for transmitting, receiving, and executing information and instructions related to the operation, monitoring, and analysis of commercial kitchen equipment described herein and for performing other related functions as described herein.

In an embodiment, the device 30 includes a plurality of components having various functions to provide a user interface, system monitoring, control, and data collection. The device 30 can be used in various applications and is described herein as adapted for commercial kitchen equipment as a particularly useful example. In an embodiment, the device can include one or more control processors, real time clock, date and time logging device, executable programs, non-volatile memory, analog signal converters for inputs and outputs, digital signal generators for inputs and outputs, interface hardware and software for interfacing with other controls (such as, for example, RS232, RS485, and similar controls), power supply, audio devices, display with or without touchscreen and with or without video or slide show capability, Wi-Fi unit, local wireless connections (Bluetooth, ZigBee), and USB interface.

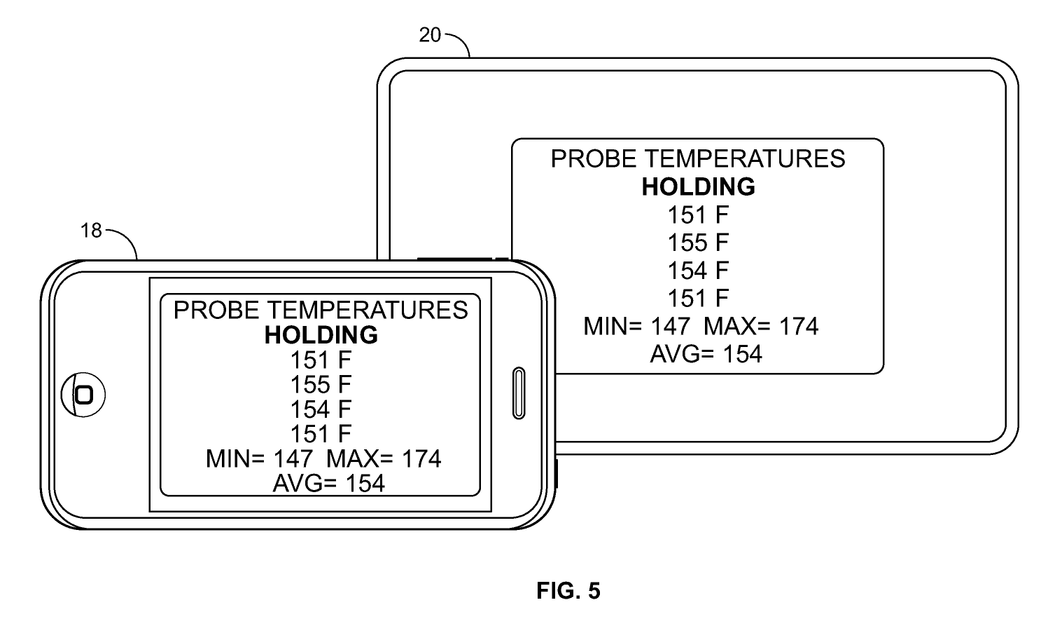

In an embodiment, the Wi-Fi unit can be adapted to host a localized web page for monitoring and control of the commercial kitchen device. This capability can also be referred to herein as an on-board web server, also referred to as an embedded web server, for the commercial kitchen unit 12. In an embodiment, the on-board web server can provide real-time data to a local device that has web browsing capability. This allows, for example, a local device and/or networked device (such as a mobile phone 18, tablet 20, and/or other personal computing device 22, 26) with standard browser application (such as Google Chrome, Internet Explorer, Firefox, etc.) to access the commercial kitchen unit 12 for controlling, monitoring, and/or analyzing the unit. For example, the web page can be customized to include information relevant for the product being cooked, the franchisee, the franchisor, maintenance personnel, and/or operator. For example, an operator can remotely monitor, manage, and watch a current batch of food being cooked. For example, FIG. 5 includes an example display of information from a commercial kitchen unit on mobile phone 18 and tablet 20. In addition, in an example, an owner can identify and monitor current product production costs based on power consumption and/or type of product cooked. In an example, a service technician and query internal systems and verify that the system is operating correctly, evaluate if the sensors are working correctly (such as whether heaters are putting out the proper heat), and evaluate the power consumption to verify that the equipment is operating within manufacturer specifications. In an embodiment, the device 30 can be adapted to allow a patron to view the cooking of their meal in an oven. For example, one of the sensors may be a video camera that generates a video feed and provides the video feed to the on-board web server. The web page may thus be configured to display the video feed when loaded at the web browser of a remote device. In an embodiment, the on-board web server can provide access to control the equipment 12 and/or program the equipment 12. In this way, the on-board server allows the equipment to be monitored, controlled, and analyzed from an access point other than the main user interface integrated on the equipment 12. In addition, this allows a secondary point of access from which to monitor, control, and analyze the equipment if the main user interface is inoperable or inaccessible.

In an embodiment, the device 30 can be adapted to send data records to a hosting server 24 for storage, access, and analysis. In an example, the data can include cycle data for each cooking batch, a notification of a service event, cycle cost information, and/or cycle reporting. The system 10 can be configured to display and allow access to such information based on a particular user's needs and role. In an example, a franchisee can see all of his stores cumulative data or that of a particular store. In an example, an equipment maintenance provider can evaluate condition of the equipment 12 and plan preventative maintenance. Such information can allow an equipment maintenance provider to evaluate the data and make sure service trips are properly prepared for with proper parts, skill set of technician, and thereby minimize down time and costs. In an example, a franchisor can monitor product quality to ensure the brand is maintained. In an example, equipment manufacturers can monitor systems for warranty verification. In an example, manufactures can monitor equipment components and use data to determine the quality and reliability of equipment components to, for example, reduce warranty events and develop action plans to maintain other examples of the equipment in the field.

In an embodiment, the system 10 can be configured to provide equipment service, operation and maintenance assistance. The system 10 can contain videos or slide shows for instructions for the operator to do basic cleaning, preventive maintenance, or normal operation. Example instructional videos can include, how to load wood chips in a commercial smoker or oven, how to clean the equipment, how to replace filters, how to program the equipment, how to operate aspects of the equipment, and equipment capabilities tutorials. In an example, the system 10 can contain video or slides for a service person to show them how to do a repair. In an example, the system can order or assist in ordering repair parts or preventive maintenance parts like filters, and other parts and consumed goods. Such feature can, for example, help ensure that the correct part is ordered. In an example, the system can assist owner/operator to do simple repairs minimizing their costs and keeping their system up as much as possible. In an example, the system can monitor and adjust power consumption during operation—which may provide cost savings and “green” operations for the user. In an example, power consumption monitoring can provide the owner/franchisee an opportunity to identify options to produce food at lower cost. In an embodiment, individual equipment components, such as heating elements, can be turned on and off and determine if they are operating within specification or need service or replacement.

In an embodiment, the system 10 can be configured to send notices regarding operation of the commercial kitchen equipment. In an example, the notices can take the form of an email, a text message, an audible message, and other forms of notices. In an example, the system can email to the owner/chef when a cycle is complete. In an example, the system can email customer service if a problem occurs. In an example, the system can generate and email the owner of a franchise an end of day report. In an example, the system can send a notice to a SMS email address that could send notices via SMS Text Messaging Services on cell phones. In an example, the system can email warnings like a power failure to allow a chef to address a problem when a machine is loaded with a large amount expensive food (such as prime rib) that is cooking overnight. Such notice would allow the user an opportunity to address the problem and save the batch. In an example, the system can email the owner when it is time to do a routine maintenance. In an example, the system can email the owner when a new recipe has been downloaded and updated.

In an embodiment, the system 10 can be configured to receive software updates related to operation of the equipment. In an example, the system can download new recipes for new products to cook or prepare. In an example, the system can download new videos and slide shows for instruction. In an example, the system can implement a “parse and stitch” techniques to overcome WiFi/internet connectivity issues, where it can download part of file at a time and when all the parts are downloaded the update can be performed.

In an embodiment, the system 10 can be configured to allow for remote operation of commercial kitchen equipment. In an example, the commercial kitchen equipment is a commercial oven 12. Remote operation and monitoring of a commercial oven is useful, for example, because it can allow a chef to be at home while monitoring and controlling an over-night cook. In an example, the system 10 can be configured to start a preheat cycle so that the machine is running and ready when staff arrives to begin cooking. In an embodiment, service can operate individual components and look at local data to determine failure points to ensure the service tech shows up with the proper tools, skills, and parts—thereby increasing uptime of the equipment.

In an embodiment, the system 10 can be configured to communicate with and control equipment associated with the kitchen equipment unit 12 on which it is installed to share resources such as power to allow for operating on lower power service installations. In an example, a system 10 incorporating a commercial oven can control an associated vent hood, exhaust valve, and water valves to reduce unnecessary consumption of resources. In an example, the system 10 can be linked with HVAC systems adjust the environment of the room ahead of equipment processes (such as heating or cooling) to maintain the environment comfortable for operators and patrons. In an example, the system can communicate or control vent hoods, water systems, HVAC systems so that they are on only when needed and thereby saving power and money. In an example, the system can be configured to provide “wake up” features where the system can go to a low power mode, common in the morning and mid-afternoon away from peak times and when new orders come in the system can “wake up” and be ready for food when operations become active.

In an embodiment, the system 10 is fully integrated and embedded into the commercial kitchen equipment unit 12. Advantages of a system integrated and embedded into the equipment include, but are not limited to, that the system 10 can perform complete diagnostics and control. In addition, unity of parts and software of the system reduce and/or eliminate complications from having parts and software from multiple providers and/or external to the equipment. Such complications can include, for example, a software update from one provider interfering with software currently running on the system or future software updates from other providers. The system 10 may also be integrated and embedded in consumer kitchen equipment.

In an embodiment, the system 10 can be implemented with an OS based computer system, such as Android and Linux. However, disadvantages of such system include that if problems arise with the OS system which interferes with the equipment, the equipment owner will have to rely on the OS provider to correct it—which such correction may not be available or available in time to prevent significant loss of use of the equipment. In addition, OS systems are vulnerable to mainstream and widespread computer viruses. OS systems can require and run a myriad of functions that are not related to monitoring or controlling the equipment and, therefore, introduce unnecessary complications into the system. In addition, the OS system may limit further customization of the system as the overall system may be limited by the capabilities of the OS system installed.

The system 10 provides for solutions to long felt needs in the commercial kitchen environment. For example, the system 10 improves reliability and uptime of commercial kitchen equipment 12. For example, for a local restaurateur or a kitchen in a school or hospital, it can be important that equipment is kept operational as much as possible. Providing nutritious meals for patients and students is important, and if the machine is down it cannot be used in preparing the food. For a restaurant a key piece of equipment can be a significant revenue resource which can be interrupted when the equipment is down. Equipment failure can also harm patronage. The system 10 allows for the equipment to be operated via other interfaces via Wi-Fi type control. This provides for access to the unit 12 if there was a display failure for example. In addition, the system 10 can report issues to provide for better service and preventive maintenance notification.

In addition, the system 10 provides for faster and more efficient maintenance of equipment 12. For example, when a piece of equipment is experiencing a problem, information regarding the problem can be communicated to a service center to be either prepared for repair or to do a service before repair is needed. In rural areas or distant locations, service personnel can arrive knowing that they have the correct parts on-hand to resolve problems they will find when they arrive without additional trips to get parts. In addition, this allows for decrease in service time and increase in production time because the equipment can be placed in operable condition sooner.

The system 10 provides for increased food quality and food quality monitoring. Many franchises have developed strong brand following based on proving a high standard of food quality that patrons have come to expect. If a facility operates differently than another, the food quality may vary and place the brand shared by all at risk. The system 10 allows franchisors and franchisees to monitor food production to help ensure that food quality standards are maintained across all franchisees.

The system 10 provides for improved food safety. It is often important that food be prepared in specific ways to ensure that the food is safe to consume. It can be critical in certain environments, such as nursing homes and hospitals, where peoples' immune systems are vulnerable. The system 10 provides for reporting system that can be monitored locally or remotely to ensure that the food is being properly prepared as well as detect any potential issues with food preparation before problems occur or food is served to patrons. The system 10 can also provide documentation to provide proof that the food preparation was not the source or cause of an unfortunate illness. In this regard, the system 10 may reduce liability exposure of the user. In addition, the system 10 can help identify potential problems as soon as possible and before they occur.

In an embodiment, the system 10 can be configured to perform product weight analysis. For example, an oven control system can be connected to a scale that is configured to measure, collect, and send data regarding the weight of a food product to the system. In an embodiment, data is received by the system 10 through a serial port. This feature allows, for example, the user to record inbound weight of food before it is cooked. The user can again weigh the outbound product after the food has been cooked. In an embodiment, the control system can store weight data so that it can be used to evaluate shrinkage. In an embodiment, the system is configured to identify any data that indicates excessive shrinkage (e.g. water loss) of a cooked product. In an embodiment, the system is configured to compare weight data generated from before and after cooking for products obtained from a single supplier or multiple suppliers to determine product variation within a single supplier and/or across multiple suppliers.

In an embodiment, the system 10 is configured to receive food product information. In an embodiment, the system is configured to receive food product information via a barcode or RFID tag. In an embodiment, food product information can be collected via portable storage device and/or transmitted wirelessly to a main server. Example food product information includes but is not limited to product type (e.g. pork roast, beef roast, ham roast), reported weight, manufacture date, expiration date, and supplier information (e.g. supplier name, supplier address, manufacture location). The food product information can be recorded before, during, and after the cooking process. In an embodiment, the collected food product information provides a record of the food preparation and performance. In an embodiment, the system is configured to time and date stamp product temperatures as product preparation moves from start to finish. In an embodiment, information from a meat probe can be used to record internal product temperature during cooking to ensure the product has been cooked throughout and is safe for consumption. In an embodiment, the system is configured to store food product information for tracking, verification of reported product weight, and/or analysis of product performance for a product supplier and/or across multiple suppliers.

In an embodiment, the system 10 is configured to provide browser based mirrored control of a kitchen equipment unit 12 such that a reproduction of the graphical user interface of the kitchen equipment unit 12 is reproduced on a remote interface device such as a mobile phone 18, tablet, or personal computer 22, 26. In an embodiment, the graphical user interface provided on the displays of the kitchen equipment unit is loaded onto a local web server of the device 30 and/or a remove server 24 the system 10. The interface loaded onto the device 10 and/or system 10 can be formatted to be identical to the interface used on the kitchen equipment unit 12. In addition, the interface can be compressed to compensate for when bandwidth is limited. The interface image data that is transferred between the web server and the application running the kitchen equipment is a single number. Communication is significantly reduced between web server and device 30 and/or system 10 running the kitchen equipment unit. The remaining secondary data, including for example, text, button presses, and mouse clicks are reduced to simple and short text strings with location information.

The local web server of the device 30 can also send a reproduction of its internal interface to additional remote servers 24 or remote devices on an “as needed” basis to provide for other remote devices to access the kitchen equipment unit 12. The local web server would share its internal interface one time over the local WiFi or the internet, to the remote device when it makes an initial connection. Once the initial connection is established, the synchronizing of screens between the kitchen equipment control and remote device are the same as the local communication device. For example, the data sent to the local screen of the kitchen equipment may also be sent to the local web server of the device 30, and the device may push the data to each remote device connected to the kitchen equipment control. Additionally or alternatively, the web page sent to a remote device may be configured to poll the kitchen equipment control (e.g., at regular or irregular intervals) for any updates to the data presented on the local screen of the kitchen equipment.

Various techniques may be selectively employed to mirror the local screen of the kitchen equipment. As noted above, the data sent to the local screen of the kitchen equipment (e.g., sensor readings), may also be provided to the local web server. The web page hosted by the local web server, in this example, may be configured with web page elements that mimic the graphics and/or layout of the local screen at the kitchen equipment. The web page elements may include placeholder elements for the data sent to the local screen of the kitchen equipment. The local web server may provide the web page to a remote device upon connection to the kitchen equipment control. As the data presented at the local screen of the kitchen equipment is updated with new data, the local web server may push the new data to the remote device, and the web browser at the remote device may update the placeholder elements of the web page to present the new data received. In another example, graphics data representing the interface presented at the local screen of the kitchen equipment may be stored in memory at the kitchen equipment. A reproduction of the graphics data may be copied to memory of the kitchen equipment control, and that graphics data may be provided to the remote device connected for display on the web page. In a further example, graphics data representing the interface presented at the local screen of the kitchen equipment may again be stored in memory at the kitchen equipment and provided to the kitchen equipment control. Upon receipt of the graphics data, the kitchen equipment control may be configured to translate or map the graphics data to a format suitable for presentation in a web page, e.g., a set of structured web page elements or an image file.

This method then allows for systems where there is no operating system (“OS”) required. For example, the browser based mirrored control described herein can operate with an OS or without. It also allows for low processing power processors because the amount of data being managed is greatly reduced. This method also allows for each different application or different revision of firmware to work across all the various installations because it uses a local copy of graphical user interfaces. Additionally, the remote device that is going to kitchen equipment control does not need any custom software beyond the web browser application typically installed on the device.

In an embodiment, the system 10 is configured to monitor for loss of connection to the Internet and send notice of lost connection over WiFi to use device 18, 20, 22. In an embodiment, the system 10 can be configured to unique passcode identifying the particular kitchen equipment device 12 being controlled, monitored, or analyzed. This ensures, for example, that maintenance personal know what device is being serviced. In addition, in an embodiment, the system 10 is configured to monitor available bandwidth on WiFi and obtain downloads or upload information when optimal bandwidth speed is available. In addition, in an embodiment, the system is configured to allow communication connectivity between either local devices 18, 20, 22 and a kitchen equipment unit 12 or remote devices 24, 26 and a kitchen equipment unit 12. Such configuration allows for the SSID to be hidden from remote Internet access while local communications are taking place between local devices and the kitchen equipment unit.

While the aspects described herein have been discussed with respect to specific examples including various modes of carrying out aspects of the disclosure, those skilled in the art will appreciate that there are numerous variations and permutations of the above described systems and techniques that fall within the spirit and scope of the invention. In addition, where reference has been made in this disclosure to items in the figures, in some instances a reference number has been omitted when it is desired to generally reference the item without specificity as to which of the plurality of items corresponding to the same base reference number.

1. A commercial kitchen equipment control and monitoring system comprising:
a commercial kitchen equipment unit, wherein the commercial kitchen equipment unit includes one or more equipment operational sensors;
an input/output unit operatively connected to the commercial kitchen equipment unit;
a wireless communications unit operatively connected to the input/output unit;
a processing unit comprising a processor and a memory unit;
wherein the system is configured via the processing unit to:
collect operating information from at least one of the equipment operational sensors of the commercial kitchen equipment unit; and
transmit via the wireless communications unit at least a portion of the operating information to a remote device.

2. The system of claim 1, wherein the commercial kitchen equipment unit is at least one of an oven, a stove, a fryer, a grill, a warmer, a smoker, a refrigerator, a mixer, a scale, a coffee maker, a drink dispenser, a holding cabinet, a rethermalizing cabinet, a freezer, a proofing cabinet, a condiment and food dispenser, a serving station, a hood, an ice cream dispenser, and a smoothie machine.

3. The system of claim 1, wherein equipment operational sensors include at least one of a temperature sensor, power sensor, fan speed sensor, voltage meter, flow meter, humidity sensor, door switch, and light switch.

4. The system of claim 1 wherein the remote device can include at least one of a mobile phone, a tablet computer, a desktop computer, a wireless router, and a remote server.

5. The system of claim 1 wherein the operating information includes at least one of temperature information, time, energy consumption rate, humidity, door open/closed, and/or cooking duration.

6. The system of claim 1 wherein the system is further configured to compare the operating information to an operation protocol associated with the commercial kitchen equipment unit, determine whether the operating information deviates from the operation protocol, and transmit via the wireless communications unit to the remote device information about any deviations from the operational protocol.

7. The system of claim 1 wherein the system is further configured to analyze the operating information and calculate an operation property.

8. The system of claim 7 wherein the operation property includes at least one of amount of energy consumption and cost of energy consumption.

9. The system of claim 1 wherein the operating information comprises batch cycle data and the remote device includes a hosting server, wherein the hosting server is configured to provide access to authorized users associated with the commercial equipment unit.

10. The system of claim 9 wherein the operating information further comprises maintenance information of the commercial kitchen equipment unit and the authorized users include equipment maintenance providers.

11. A commercial kitchen equipment control and monitoring system comprising:
a commercial kitchen equipment unit, wherein the commercial kitchen equipment unit includes equipment operational sensors;
an input/output unit operatively connected to the commercial kitchen equipment unit;
a wireless communications unit operatively connected to the input/output unit, the wireless communications unit including an on-board web server configured to host a web page;
a processing unit comprising a processor and a memory unit; and
wherein the system is configured via the processing unit to:
provide the web page to a remote device in networked communication with the wireless communication unit to control and/or monitor operation of the commercial kitchen equipment via the web page.

12. The system of claim 11 wherein the system is further configured to configure the web page based on operational information generated by one or more of the equipment operational sensors.

13. The system of claim 11 wherein the operational information includes at least one of temperature information, time, energy consumption rate, humidity, door open/closed, and/or cooking duration.

14. The system of claim 11 wherein the operational information includes maintenance information of the commercial kitchen equipment unit and the web server is configured to provide the web page to authorized users associated with the commercial equipment unit, the authorized users including equipment maintenance providers.

15. The system of claim 11 wherein the remote device can include at least one of a mobile phone, a tablet computer, a desktop computer, and a remote server.

16. A commercial kitchen equipment control and monitoring system comprising:
a commercial kitchen equipment unit;
an input/output unit operatively connected to the commercial kitchen equipment unit;
an equipment display operatively connected to the input/output unit, wherein the equipment display includes a graphical user interface configured for user control of the commercial kitchen equipment through the graphical user interface;
a wireless communications unit operatively connected to the input/output unit and/or the equipment display, the wireless communications unit including an on-board web server configured to host a web page;
a processing unit comprising a processor and a memory unit; and
wherein the system is configured via the processing unit to:
provide the web page to a remote device in networked communication with the wireless communication unit to control and/or monitor operation of the commercial kitchen equipment via the web page; and
configure the web page to display on the remote device a reproduction of the graphical user interface of the equipment display such that a visual appearance of the graphical user interface used to control the commercial kitchen equipment unit via the equipment display and a visual appearance of the reproduction of the graphical user interface on the remote device are substantially the same.

17. The system of claim 16 wherein the web page is configured to provide operational control of the commercial kitchen equipment from the remote device in real-time via the on-board web server.

18. The system of claim 16 wherein the system is further configured to configure the web page based on operational information of the commercial kitchen equipment and the operational information includes at least one of temperature information, time, energy consumption rate, humidity, door open/closed, and/or cooking duration.

19. The system of claim 16 wherein the operational information includes maintenance information of the commercial kitchen equipment unit.

20. The system of claim 16 wherein the remote device can include at least one of a mobile phone, a tablet computer, a desktop computer, and a remote server.
